(19) United States
(12) Patent Application Publication
(10) Pub. No.: US 2004/0140746 A1
(43) Pub. Date: Jul. 22, 2004

(54) Self-ballasted electrodeless fluorescent lamp and electrodeless fluorescent lamp operating device

(76) Inventors: Toshiaki Kurachi, Osaka (JP); Kenji Itaya, Osaka (JP)

Correspondence Address: HARNESS, DICKEY & PIERCE, P.L.C., P.O. BOX 828, BLOOMFIELD HILLS, MI, 48303, US

(21) Appl. No.: 10/755,252

(22) Filed: Jan. 9, 2004

(30) Foreign Application Priority Data
Jan. 15, 2003 (JP) 2003-006820

(51) Int. Cl. H01J 1/50; H01J 23/10

(52) U.S. Cl. 313/153; 313/157

(57) ABSTRACT

A winding rod 104a of a bobbin 104 around which a winding 103 of an induction coil 109 is wound is inserted into a re-entrant part 120 of a luminous bulb 101. Plural projections 108, 108, . . . are provided on the winding rod 104a. These projections 108, 108, . . . project toward the wall surface of the re-entrant part 120 beyond the winding 103 of the induction coil 109. The winding 103 of the induction coil 109 is formed closer to the winding rod 104a than a virtual line linking between the adjacent corners of the adjacent projections 108 and 108 in the circumferential direction of the winding rod 104a.

### BACKGROUND OF THE INVENTION

(1) Technical Field

The present invention relates to a self-ballasted electrodeless fluorescent lamp and an electrodeless fluorescent lamp operating device, and more particularly to a self-ballasted electrodeless fluorescent lamp and an electrodeless fluorescent lamp operating device in each of which an induction coil wound around a winding rod of a bobbin is inserted into a re-entrant part of a luminous bulb.

(2) Background Art

Fluorescent lamps have a higher efficiency and a longer life than incandescent lamps and have been therefore widely used in consideration of global environmental protection and cost efficiency. In recent years, attention has been focused on electrodeless fluorescent lamps having no electrode as economical light sources and demand for them has tended to rise, because they have several times as long a lifetime as known fluorescent lamps with electrodes.

Furthermore, self-ballasted fluorescent lamps in which a fluorescent lamp is integrated with a ballast circuit as one unit receive attention as light sources of low energy consumption in houses, hotels, restaurants, or the like, and they are being widely used in those places also because of their convenience that they can be utilized, as they are, in place of incandescent lamps. The self-ballasted fluorescent lamps have been developed for electrodeless fluorescent lamps as well as fluorescent lamps with electrodes (see, for example, Japanese Laid-Open Patent Application Publication No. 9-320541 and Japanese Laid-Open Patent Application Publication No. 11-102667).

Japanese Laid-Open Patent Application Publication No. 9-320541 describes a fluorescent lamp shown in FIG. 10 as this kind of electrodeless fluorescent lamp. This electrodeless fluorescent lamp comprises a discharge vessel 801 consisting of a glass vessel, a ballast circuit 805 for generating a high frequency, a ballast circuit case cover 808, and a lamp base 804 for connecting with a commercial power supply. The discharge vessel 801 is of a generally spherical appearance and has a cylindrical part extending from its bottom to inside, and there is provided an excitation coil 807 wound around a ferrite 806 in the cylindrical part. The excitation coil 807 is supplied with a high frequency voltage from the ballast circuit 805 to generate a high frequency electromagnetic field, thereby allowing discharge gas in the discharge vessel 801 to discharge and radiate ultraviolet light. This ultraviolet light causes a fluorescent material 802 on the inner surface of the discharge vessel 801 to emit visible light. A light-transmissive conductive film 803 provided on the inner surface of the discharge vessel 801 prevents the high frequency electromagnetic field from leaking out of the lamp.

However, when the diameter of the excitation coil 807 is increased to allow the electrodeless fluorescent lamp to generate electrical discharge efficiently, blackening progresses in the cylindrical part of the discharge vessel 801 with increased burning hours, resulting in a shortened life of the lamp. More particularly, when the excitation coil 807 comes into contact with the cylindrical part, blackening is caused in a short time.

It is considered that, as described in Japanese Laid-Open Patent Application Publication No. 11-102667, the reason why blackening is caused is that ions in plasma or the like are attracted to the inner wall of the discharge vessel by a high electric field caused by a potential difference between adjacent turns of the winding of the excitation coil to come into collision with the inner wall thereof. The occurrence of such blackening causes mercury in discharge gas to adhere to the blackened portion of the discharge vessel. Thus, the quantity of mercury in the discharge gas decreases over the course of time so that the quantity of emitted light decreases.

In a technique described in Japanese Laid-Open Patent Application Publication No. 11-102667, a shield tube is inserted between the excitation coil and the cylindrical part of the discharge vessel to shield the electric field, thereby avoiding such blackening. However, an eddy current is produced in the shield tube, thereby causing current dissipation. In particular, when the operating frequency is relatively low, for example, several tens kHz through several hundreds kHz, the lamp becomes difficult to operate due to eddy current dissipation. Even when the occurrence of an eddy current is suppressed by slitting the shield tube as described in Japanese Laid-Open Patent Application Publication No. 11-102667, eddy current dissipation cannot become zero, and therefore the above-mentioned phenomenon caused by an eddy current cannot be completely eliminated.

### SUMMARY OF THE INVENTION

The present invention is made in view of the above-described circumstances, and it is an object thereof to provide a long-life self-ballasted electrodeless fluorescent lamp and a long-life electrodeless fluorescent lamp operating device by suppressing the blackening of a discharge vessel.

A first self-ballasted electrodeless fluorescent lamp of the present invention comprises: a luminous bulb enclosing light-emitting gas containing at least mercury and having a generally tubular re-entrant part; an induction coil having a winding and a core, said induction coil being inserted into the re-entrant part; a bobbin having a winding rod around which the winding of the induction coil is wound; a ballast circuit for supplying high-frequency power to the induction coil; and a base electrically connected to the ballast circuit, wherein the luminous bulb, the induction coil, the ballast circuit, and the base are constructed as one unit, at least one projection projecting toward the tubular wall surface of the re-entrant part is provided on the winding rod, and the projection projects toward the tubular wall surface beyond the winding of the induction coil.

A second self-ballasted electrodeless fluorescent lamp of the present invention comprises: a luminous bulb enclosing light-emitting gas containing at least mercury and having a generally tubular re-entrant part; an induction coil having a winding obtained by winding a conductive wire and a core, said induction coil being inserted into the re-entrant part; a bobbin having a winding rod around which the winding of the induction coil is wound; a ballast circuit. for supplying high-frequency power to the induction coil; and a base electrically connected to the ballast circuit, wherein the luminous bulb, the induction coil, the ballast circuit, and the base are constructed as one unit, the winding of the induction coil is wound with it split into plural parts in a direction of the central axis of the winding rod by providing, between adjacent turns of the conductive wire located somewhere therealong, a gap running over the whole circumference of the winding rod, a projection projecting toward the tubular wall surface of the re-entrant part is provided at least partly on a portion of the winding rod corresponding to the gap to separate the adjacent turns of the conductive wire from each other, and the projection projects toward the tubular wall surface beyond the winding of the induction coil.

It is preferable that the winding rod is tubular, that a plurality of the projections exist and that the induction coil is formed closer to the winding rod than a line linking between the adjacent corners or distal ends of the adjacent projections in the circumferential direction of the winding rod. The line linking between the adjacent corners or distal ends of the adjacent projections is a virtual line.

It is preferable that the winding rod is tubular and that the projection has a generally annular shape partly formed with a cutout and is continuously formed over 320 or more degrees in the circumferential direction of the winding rod.

The distance between the outer surface of the induction coil and the distal end of the projection is 0.4 mm through 1.0 mm both inclusive.

In one embodiment, the high-frequency power has a frequency of 50 kHz through 1 MHz both inclusive.

A first electrodeless fluorescent lamp operating device of the present invention comprises: a luminous bulb enclosing light-emitting gas containing at least mercury and having a generally tubular re-entrant part; an induction coil inserted into the re-entrant part; a bobbin having a winding rod around which the induction coil is wound; and a ballast circuit for supplying high-frequency power to the induction coil, wherein the winding rod is tubular and has a plurality of projections projecting toward the tubular wall surface of the re-entrant part, the projections project toward the tubular wall surface beyond the induction coil, and the induction coil is formed closer to the winding rod than a line linking between the adjacent corners or distal ends of the adjacent projections in the circumferential direction of the winding rod. The line linking between the adjacent corners or distal ends of the adjacent projections is a virtual line.

It is preferable that the induction coil has a conductive wire and is wound with it split into plural parts in a direction of the central axis of the winding rod by providing, between adjacent turns of the conductive wire located somewhere therealong, a gap running over the whole circumference of the winding rod and that the projections are provided on a portion of the winding rod corresponding to the gap to separate the adjacent turns of the conductive wire from each other.

A second electrodeless fluorescent lamp operating device of the present invention comprises: a luminous bulb enclosing light-emitting gas containing at least mercury and having a generally tubular re-entrant part; an induction coil inserted into the re-entrant part; a bobbin having a winding rod around which the induction coil is wound; and a ballast circuit for supplying high-frequency power to the induction coil, wherein the winding rod is tubular and has a projection projecting toward the tubular wall surface of the re-entrant part, and the projection projects toward the tubular wall surface beyond the induction coil, has a generally annular shape provided with a cutout, and is continuously formed over 320 or more degrees in the circumferential direction of the winding rod.

The distance between the outer surface of the induction coil and the distal end of the projection is 0.4 mm through 1.0 mm both inclusive.

In one embodiment, the high-frequency power has a frequency of 50 kHz through 1 MHz both inclusive.

### BRIEF DESCRIPTION OF THE DRAWINGS

FIG. 1 is a partial cross sectional view schematically showing a self-ballasted electrodeless fluorescent lamp according to a first embodiment of the present invention.

FIG. 2A is a view of a bobbin of the first embodiment as seen from the top of FIG. 1, and FIG. 2B is an enlarged view of a part of FIG. 2A

FIG. 3 is a top view of a bobbin according to a modification of the first embodiment.

FIG. 4 is a partial cross sectional view schematically showing a self-ballasted electrodeless fluorescent lamp according to a second embodiment of the present invention.

FIG. 5 is a view of a bobbin of the second embodiment as seen from the top of FIG. 4.

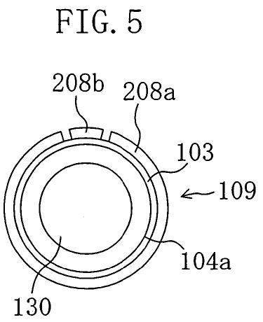

FIGS. 6A and 6B are front and top views of a bobbin of a self-ballasted electrodeless fluorescent lamp according to a third embodiment of the present invention, respectively.

FIGS. 7A and 7B are front and top views of a bobbin of a self-ballasted electrodeless fluorescent lamp according to a fourth embodiment of the present invention, respectively.

FIGS. 8A and 8B are front and top views of a bobbin of a self-ballasted electrodeless fluorescent lamp according to a fifth embodiment of the present invention, respectively.

FIGS. 9A and 9B are front and top views of a bobbin of a self-ballasted electrodeless fluorescent lamp according to a sixth embodiment of the present invention, respectively.

FIG. 10 is a partial cross sectional view schematically showing a known self-ballasted electrodeless fluorescent lamp described in Japanese Laid-Open Patent Application Publication No. 9-320541.

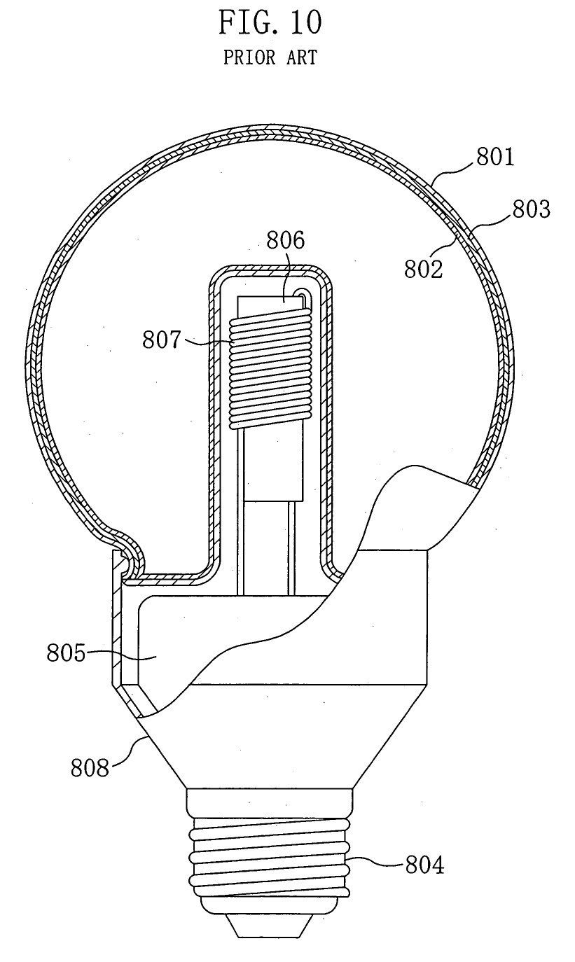

### DETAILED DESCRIPTION OF THE INVENTION

Embodiments of the present invention will be described hereinafter with reference to the drawings. For the sake of simplicity, the same reference numerals are given to the components having substantially the same functions. It is to be noted that the present invention is not limited to the following embodiments.

(Embodiment 1)

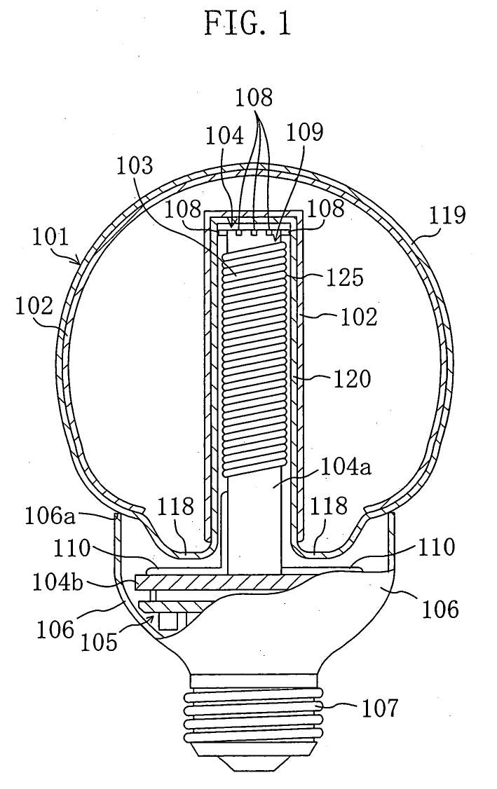

As shown in FIG. 1, a self-ballasted electrodeless fluorescent lamp of this embodiment comprises a luminous bulb 101 enclosing luminous gas containing at least mercury inside and including a generally tubular (cylindrical in this embodiment) re-entrant part 120, an induction coil 109 inserted into the re-entrant part 120 and including a winding 103 and a core (not shown), a bobbin 104 including a winding rod 104a around which the winding 103 of the induction coil 109 is wound, a ballast circuit 105 for supplying high-frequency power to the induction coil 109, and a base 107 (lamp base) connectable to a commercial power supply, and further includes a housing 106 containing the ballast circuit 105. The luminous bulb 101, the induction coil 109, the bobbin 104, the ballast circuit 105, and the base 107 are constructed as one unit.

Furthermore, the winding rod 104a is provided with projections 108, 108, . . . projecting toward the tubular wall surface of the re-entrant part 120. These projections 108, 108, . . . project toward the tubular wall surface of the re-entrant part 120 beyond the winding 103 of the induction coil 109.

The present inventors found that the re-entrant part 120 is prevented from blackening by constructing the electrodeless fluorescent lamp as described above, i.e., even when a shield tube is not placed between the re-entrant part 120 and the induction coil 109, blackening can be avoided by properly keeping the distance between the re-entrant part 120 and the induction coil 109.

When an induction coil is formed by winding a conductive wire around a simple cylindrical bobbin winding rod including no projection 108, 108, . . . , the re-entrant part and the induction coil may not be kept at such a distance from each other that blackening is not caused, depending on the tolerance of each of the bobbin, the induction coil and the re-entrant part. In this case, the shield tube for avoiding blackening is essential. Also when an induction coil is formed by winding a conductive wire around a ferrite core without using a bobbin, it is difficult to surely keep the re-entrant part and the induction coil at such a distance from each other that blackening is not caused. Thus, a shield tube must be used likewise. However, according to the present invention, blackening can certainly be avoided by providing projections 108, 108, . . . , on the winding rod 104a of the bobbin 104.

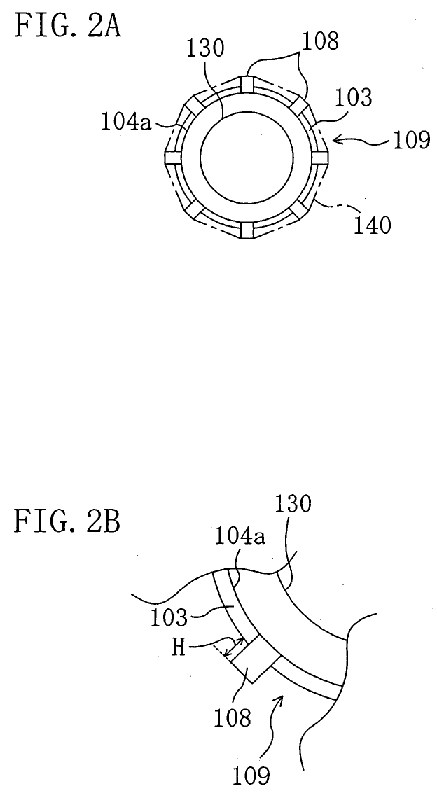

These projections 108, 108, . . . will be further described. Each of the projections 108, 108, . . . has a rectangular parallelepiped shape. As shown in FIG. 2A, eight projections 108, 108, . . . are provided on the head of the winding rod 104a at substantially equal intervals in the circumferential direction and project perpendicularly from the winding rod 104a toward the tubular wall surface of the re-entrant part 120. A cylindrical core (ferrite core) 130 for increasing the inductance of the induction coil 109 is inserted into an axial bore of the winding rod 104a. The winding 103 of the induction coil 109 is formed inside a virtual line 140 linking between the adjacent corners of the two projections 108 and 108 adjacent in the circumferential direction of the winding rod 104a, i.e., closer to the winding rod 104a than the virtual line 140. Herein, the circumferential direction of the winding rod 104a represents the direction of revolution as the axis of which the central axis of the tubular winding rod 104a is assumed.

As described above, the winding 103 of the induction coil 109 is formed closer to the winding rod 104a than the virtual line 140 linking between the adjacent corners of the two adjacent projections 108 and 108. Therefore, even when the winding rod 104a of the bobbin 104 is inclined in the re-entrant part 120, any one of the projections 108 hits the wall surface of the re-entrant part 120 before the winding 103 of the induction coil 109 comes into contact with the wall surface of the re-entrant pair 120, thereby blocking the induction coil 109 from moving closer to the wall surface of the re-entrant part 120. That is, the projections 108, 108, . . . prevent the winding 103 of the induction coil 109 from coming into contact with the wall surface of the re-entrant part 120. Therefore, blackening can surely be prevented from occurring on the wall surface of the re-entrant part 120 located inside the luminous bulb 101.

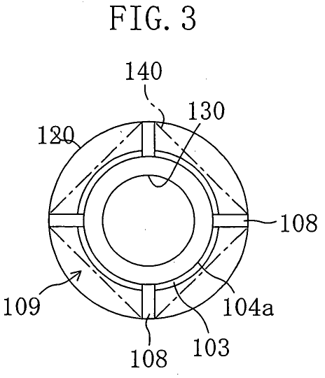

As long as the winding 103 of the induction coil 109 is formed closer to the winding rod 104a than the virtual line 140 linking between the adjacent corners of two adjacent projections 108 and 108 in this way, even when four projections 108, 108, . . . are provided at equal intervals in the circumferential direction of the winding rod 104a as in a modification of this embodiment shown in FIG. 3, the winding 103 of the induction coil 109 is prevented from coming into contact with the wall surface of the re-entrant part 120, whereby blackening is prevented from occurring on the wall surface of the re-entrant part 120 located inside the luminous bulb 101. When projections have a shape like this, it is preferable that there exist three or more projections 108, 108, . . . , because they can surely avoid blackening.

Furthermore, as shown in FIG. 2B, in this embodiment, the distance H between the distal end of each of the projections 108, 108, . . . and the outer surface of the induction coil 109 is within the range between 0.4 mm and 1.0 mm both inclusive. The outer surface of the induction coil 109 herein represents the surface of the winding 103, constituting the induction coil 109 that faces toward the re-entrant part 120. A stranded wire obtained by twisting plural wires is used as a conductive wire 125 of this embodiment to allow a high-frequency current to flow therethrough. When the winding 103 of the induction coil 109 is formed by winding the stranded wire around the winding rod 104a, the stranded wire becomes flat so that the diameter of the stranded wire becomes small in the radial direction of the winding rod 104a. Therefore, it is undesirable that the distance H should be smaller than 0.4 mm, because part of the conductive wire 125 constituting the induction coil 109 might come close to the re-entrant part to reach within the distance at which blackening is caused, depending on the shortage in the degree of flattening of the stranded wire. On the other hand, it is also undesirable that the distance H should become larger than 1.0 mm, because the discharge efficiency in the luminous bulb 101 would be lowered.

Next, the self-ballasted electrodeless fluorescent lamp of this embodiment will be further described. This self-ballasted electrodeless fluorescent lamp is also an electrodeless fluorescent lamp operating device comprising a luminous bulb 101, an induction coil 109, a bobbin 104, and a ballast circuit 105.

The luminous bulb 101 is composed of a generally spherical external bulb 119 and an internal bulb defining the re-entrant part 120. This re-entrant part 120 has a generally tubular shape (cylindrical shape) including an aperture on the ballast circuit 105 side. The generally tubular shape herein represents a tubular shape including a shape in which the re-entrant end is closed, a shape in which a portion of the re-entrant part 120 connected to the external bulb 119 is flared, and like shapes. The shape of the external bulb 119 is a so-called eggplant shape or pear shape. This shape can include, for example, an A-type shape or a P-type shape defined in JIS C 7710-1988 or IEC 60887-1988.

This luminous bulb 101 is a vessel made of glass enclosing mercury as a luminous material and a rare gas as a buffer gas (for example, krypton or argon) inside. Mercury is enclosed in liquid or amalgam form in the luminous bulb 101 and heated by plasma during operation to provide a vapor pressure defined by the temperature at the heating. The inner volume of the luminous bulb 101 is, for example, 100 through 270 cm³, and 2 through 10 mg of mercury and krypton having an enclosing pressure of 50 through 300 Pa (at 25° C.) are enclosed in the luminous bulb 101.

A fluorescent material 102 for converting ultraviolet light produced by electrical discharge in the luminous bulb 101 into visible light is applied to the inside (inner wall) of the luminous bulb 101. The luminous bulb 101 is formed by fusion bonding the outer re-entrant edge of the cylindrical internal bulb (re-entrant part 120) in which the induction coil 109 can be placed to a part of the generally spherical external bulb 119 to which the fluorescent material 102 is applied by using flame from a burner or the like. This fused portion is a sealing portion 118. The fluorescent material 102 is not applied to this sealing portion 118. The reason for this is that this portion is fused at the end of the production of the luminous bulb 101 and therefore the fluorescent material 102 cannot be applied thereto.

Here, the size and the like of the luminous bulb 101 according to this embodiment will be described as an example. The outer diameter of the middle section of the luminous bulb 101 (i.e., the outer diameter of the largest part thereof) is 50 through 90 mm (material thickness: about 1 mm). The heights of the luminous bulb 101 and the electrodeless fluorescent lamp including the base 107 are, for example, 60 through 80 mm and 130 through 240 mm, respectively. The internal diameter of the re-entrant part 120 of the luminous bulb 101 is, for example, 16 through 26 mm. Although the luminous bulb 101 is composed of, for example, soda lime glass, it may be composed of borosilicate glass or the like.

The ballast circuit 105 is connected to the winding 103 of the induction coil 109 located in the re-entrant part 120 and supplies high-frequency power to the winding 103. As shown in FIG. 1, in order to effectively produce electrical discharge within the luminous bulb 101, the induction coil 109 for generating a high-frequency electric field is provided substantially in the center of the luminous bulb 101. A circuit board in which the ballast circuit 105 serving as a high-frequency power supply is formed is housed in the housing 106, and power is externally supplied through the base 107 to the circuit board.

This base 107 has a structure in which it can be screwed into a socket for an incandescent lamp. Therefore, a self-ballasted electrodeless fluorescent lamp can be electrically connected to an external power supply (for example, commercial power supply) simply by screwing the base 107 into a socket. The self-ballasted electrodeless fluorescent lamp of this embodiment not only can be used with it screwed into a socket but also has a size and appearance close to those of an incandescent lamp. Therefore, it can be used for the same use as that of the incandescent lamp and can directly be replaced with the incandescent lamp.

In addition, the bobbin 104 consists of the winding rod 104a around which the conductive wire 103 constituting the induction coil 109 is wound, and a substratum part 104b that is placed substantially perpendicularly to this winding rod 104a and supports the winding rod 104a. The winding rod 104a is cylindrical and is inserted into the re-entrant part 120. The substratum part 104b expands substantially perpendicularly from an end of the winding rod 104a located closer to the base 107 to have a disc shape, and is placed between the luminous bulb 101 and the ballast circuit 105. This substratum part 104b is generally horizontally placed when the central axis of the re-entrant part 120 is directed in the vertical direction.

Furthermore, the substrate of the ballast circuit 105 is typically a printed board. In this embodiment, like the substratum part 104b of the bobbin 104, the substrate of the ballast circuit 105 is generally horizontally placed when the central axis of the re-entrant part 120 is directed vertically. The substratum part 104b and the substrate of the ballast circuit 105 are placed substantially parallel to each other.

A connection wire 110 for electrically connecting the induction coil 109 to the ballast circuit 105 extends from the lower end of the winding 103 constituting the induction coil 109 (the portion thereof closest to the substratum part 104b) toward the base 107 along the winding rod 104a, and further extends away from the central axis of the luminous bulb 101 (which substantially coincides with the central axis of the re-entrant part 120) along the surface of the substratum part 104b located closer to the luminous bulb 101. The connection wire 110 passes through the substratum part 104b in the vicinity of the outer edge of the substratum part 104b and further extends to the circuit board so as to be connected to the ballast circuit 105.

This connection wire 110 is placed apart from the sealing portion 118 between the external bulb 119 and the re-entrant part 120. The luminous bulb 101 is supported by a top end 106a of the housing 106 that is an end of the housing 106 opposite to the base 107, and the housing 106 lifts the luminous bulb 101 at the top end 106a to place the connection wire 110 located along the substratum part 104b of the bobbin 104 apart from the sealing portion 118 between the external bulb 119 and the re-entrant part 120. Although the connection wire 110 is made of the conductive wire 125 extending from the end of the induction coil 109 and constituting the induction coil 109 itself in this embodiment, the connection wire 110 is not restricted to a part of this induction coil 109 but whatever electrically connects the ballast circuit 105 to the induction coil 109 can be used. The reason why the connection wire 110 is placed apart from the sealing portion 118 is that the inner wall of the sealing portion 118 is prevented from blackening. It is preferable that an insulative and heat-resistant material such as silicone is applied to a gap between this connection wire 110 and the sealing portion 118, because the distance therebetween can be ensured.

The housing 106 is made of a heat-resistant material. In this embodiment, it is made of heat-resistant resin (for example, polybutylene terephthalate). In order to improve heat dissipation, the housing 106 can be made of a material having an excellent heat-conductivity (for example, metal or the like).

Next, the operation of the self-ballasted electrodeless fluorescent lamp of this embodiment will be described briefly. When commercial alternating-current power is supplied via the base 107 to the ballast circuit 105, the ballast circuit 105 converts the commercial alternating-current power into high-frequency alternating-current power and supplies the converted power to the induction coil 109. The frequency of the high-frequency power to be supplied by the ballast circuit 105 is, for example, 50 kHz through 1 MHz, and the power to be supplied by the ballast circuit 105 is, for example, 5 through 200W. When the induction coil 109 receives the supply of the high-frequency power, a high-frequency alternating-current magnetic field is formed in a space located in the vicinity of the induction coil 109. Thus, an induction electrical field is produced to be orthogonal to the high-frequency alternating-current magnetic field so that light-emitting gas inside the luminous bulb 101 is excited to emit light. Consequently, light in an ultraviolet spectrum range or a visible spectrum range can be emitted. The emitted light in the ultraviolet spectrum range is converted into light in a visible spectrum range (visible light) by the fluorescent material 102 formed on the inner wall of the luminous bulb 101. A lamp utilizing the light emission in the ultraviolet spectrum range (or the light emission in the visible spectrum range) as it is without forming the fluorescent material 102 can be constructed. The light emission in the ultraviolet spectrum range is principally caused by mercury. More particularly, in the case where a high-frequency current is allowed to flow into the induction coil 109 put in the vicinity of the luminous bulb 101, mercury atoms and electrons come into collision with each other in the luminous bulb 101 because of an induction electrical field formed by magnetic fields of force resulting from electromagnetic induction, so that excited mercury atoms radiate ultraviolet light.

Here, the frequency of an alternating current supplied by the ballast circuit 105 will be described. In this embodiment, the frequency of an alternating current supplied by the ballast circuit 105 is within a range of relatively low frequencies of 1 MHz or less (for example, 50 kHz through 1 MHz) as compared with 13.56 MHz or several MHz of an ISM frequency band that is practically and typically used. The reason why a frequency within such a low-frequency range is employed will be described as follows. First, when the lamp is operated within a relatively high-frequency range such as 13.56 MHz or several MHz, a noise filter for suppressing line noises produced by the ballast circuit 105 becomes large, resulting in an enlarged volume of the ballast circuit 105. Furthermore, a very strict regulation over high-frequency noises is instituted by a law. Thus, when noises radiated or propagated from the lamp are high-frequency noises, in order to satisfy the regulation, the lamp need be used with an expensive shielding provided therein, resulting in a large obstacle to cost reduction. On the other hand, when the lamp is operated within a range of frequencies of approximately 50 kHz through 1 MHz, an inexpensive product for general purpose use that is used as an electronic component for general electronic equipment can be used as a member constituting the ballast circuit 105, and a member having a small size can be used. Therefore, cost reduction and miniaturization can be achieved, thereby providing a big advantage. However, the self-ballasted electrodeless fluorescent lamp of this embodiment cannot only be operated under 1 MHz or less but also can be operated within another frequency range such as 13.56 MHz or several MHz.

According to the structure of this embodiment, the projections 108, 108, . . . are provided on the winding rod 104a of the bobbin 104, and the projections 108, 108, . . . are projected higher than the winding 103 of the induction coil 109 toward the wall surface of the re-entrant part 120. Therefore, the winding 103 of the induction coil 109 is blocked from coming into contact with the re-entrant part 120, whereby blackening is prevented from occurring on the inner wall of the re-entrant part 120 when this self-ballasted electrodeless fluorescent lamp is operated. Furthermore, the winding 103 of the induction coil 109 is provided closer to the winding rod 104a than the virtual line 140 linking between the adjacent corners of the adjacent projections 108, 108, . . . in the circumferential direction of the winding rod 104a. Therefore, even when the winding rod 104a of the bobbin 104 is inclined within the re-entrant part 120, the winding 103 of the induction coil 109 can surely be blocked from coming into contact with the re-entrant part 120. Since these projections 108, 108, . . . are formed with the bobbin 104 as one unit, they can be produced at low cost.

(Embodiment 2)

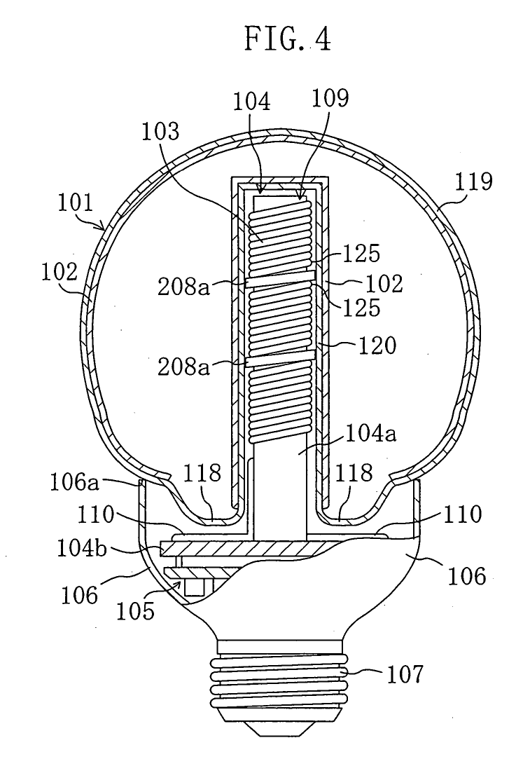

A self-ballasted electrodeless fluorescent lamp of this embodiment comprises a split-wound induction coil 109 as shown in FIG. 4. Split winding represents a way of winding in which while a winding 103 of the induction coil 109 is formed by winding a conductive wire 125 around a winding rod 104a, a gap is provided between the adjacent turns of the conductive wire 125 over the whole circumference of the winding rod 104a and the conductive wire 125 is then further continued to be wound. In this embodiment, the conductive wire 125 is wound with it split in three in a direction of the central axis of the winding rod 104a. Pairs of projections 208a, 208b and 208a, 208b, each pair defined by two cutouts on the whole circumference of the winding rod 104a and projecting from the winding rod 104a like a collar, are formed in these gaps. Each of the pairs of projections 208a, 208b and 208a, 208b separate the adjacent turns of the conductive wire 125 from each other and project closer to the tubular wall surface of the re-entrant part 120 than the induction coil 109. The projection height of each of the pairs of projections 208a, 208b and 208a, 208b is substantially constant along the circumferential direction. The two upper and lower pairs of projections 208a, 208b and 208a, 208b when viewed in FIG. 4 have the same shape, and it can be said that each of them have a generally annular shape in which two cutouts are formed. Furthermore, the conductive wire 125 is also placed in two cutouts to connect the split parts of the coil to each other. The winding 103 of the induction coil 109 is provided closer to the winding rod 104a than a virtual line linking between the adjacent corners of the pair of adjacent projections 208a and 208b with the cutouts interposed therebetween.

Use of split winding in this manner allows a voltage that is to be applied to each of the slit parts of the induction coil 109 to become low in accordance with the number of splitting even when a voltage to be applied to the whole induction coil 109 is high. That is, since the conductive wire is split in three in this embodiment, one-third of the whole voltage is applied to each of the split parts of the coil so that the coil is less likely to cause insulation breakdown. Therefore, split winding itself offers a great advantage. Besides, in this embodiment, separation bands (splitting walls) for implementing the above-described splitting are also used as the pairs of projections 208a and 208b and 208a and 208b for preventing the winding 103 of the induction coil 109 from coming into contact with the re-entrant part 120. Therefore, both the effects of the separation bands and the pairs of projections can be obtained without increasing any component, thereby reducing total cost.

The distance between the distal end of each of the projections 208a and 208b and 208a and 208b and the outer surface of the induction coil 109 is within the range between 0.4 mm and 1.0 mm both inclusive. Therefore, the winding 103 of the induction coil 109 can surely be prevented from coming into contact with the re-entrant part 120, thereby providing a high discharge efficiency.

According to the structure of this embodiment, the separation bands provided on the winding rod 104a by split winding serve as the pairs of projections 208a and 208b and 208a and 208b projecting closer to the re-entrant part 120 than the winding 103 constituting the induction coil 109, so that the winding 103 of the induction coil 109 is blocked from coming into contact with the re-entrant part 120, thereby preventing blackening from occurring on the inner wall of the re-entrant part 120 when this self-ballasted electrodeless fluorescent lamp is operated.

The self-ballasted electrodeless fluorescent lamp of this embodiment is also an electrodeless fluorescent lamp operating device comprising the luminous bulb 101, the induction coil 109, the bobbin 104, and the ballast circuit 105.

(Embodiment 3)

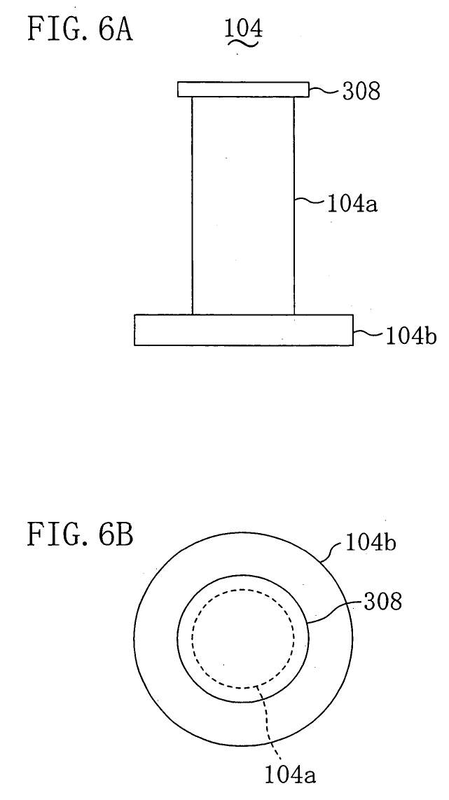

FIG. 6 shows a bobbin 104 used for a self-ballasted electrodeless fluorescent lamp of this embodiment. In the self-ballasted electrodeless fluorescent lamp of this embodiment, components other than a projection 308 provided on the bobbin 104 are the same as those of the first embodiment. Thus, the projection 308 will be principally described.

A winding rod 104a of the bobbin 104 used for the self-ballasted electrodeless fluorescent lamp of this embodiment is provided with a projection 308 on an end thereof opposite to a substratum part 104b. This projection 308 is formed to have a shape in which a disc is attached to the end of the winding rod 104a. This disc is placed coaxially with the winding rod 104a, and the diameter of the disc is larger than the diameter of the winding rod 104a. When a winding 103 of an induction coil 109 is provided around the winding rod 104a, the projection 308 projects beyond the winding 103 of the induction coil 109 toward the wall surface of a re-entrant part 120. Therefore, the winding 103 of the induction coil 109 can surely be prevented from coming into contact with the re-entrant part 120, thereby certainly avoiding blackening.

Furthermore, the distance between the distal end of the projection 308 and the outer surface of the induction coil 109 is within the range between 0.4 mm and 1.0 mm both inclusive. Therefore, the induction coil 109 can surely be prevented from coming into contact with the re-entrant part 120, and the discharge efficiency can be enhanced.

Although in this embodiment the projection 308 has a shape in which a disc is attached to the winding rod 104a, it may have a shape in which a ring, instead of the disc, is attached thereto. In this case, the internal diameter of the ring is equivalent to the diameter of the winding rod 104a.

(Embodiment 4)

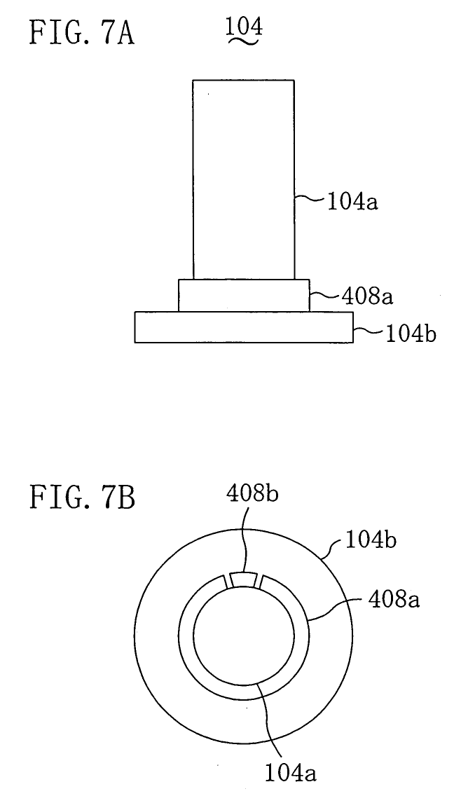

FIG. 7 shows a bobbin 104 used for a self-ballasted electrodeless fluorescent lamp of this embodiment. In the self-ballasted electrodeless fluorescent lamp of this embodiment, components other than a pair of projections 408a and 408b provided on the bobbin 104 are the same as those of the first embodiment. Thus, the pair of projections 408a and 408b will be principally described.

A winding rod 104a of the bobbin 104 used for the self-ballasted electrodeless fluorescent lamp of this embodiment is provided with a pair of projections 408a and 408b on its portion connected to a substratum part 104b. The pair of projections 408a and 408b has a shape in which a doughnut-shaped, punched disc is fitted onto the portion of the winding rod 104a that is connected to the substratum part 104b and two portions of the punched disc are cut out. That is, it has a shape in which two cutouts are formed in an annular plate provided like a collar at a constant amount of projection over the whole circumference of the winding rod 104a. These cutouts are where a connection wire for connecting an induction coil 109 to a ballast circuit 105 is placed. Furthermore, the winding 103 of the induction coil 109 is provided closer to the winding rod 104a than a virtual line linking between the adjacent corners of the two adjacent projections 408a and 408b with the cutouts interposed therebetween. When the winding 103 of the induction coil 109 is provided around the winding-rod 104a, the projections 408a and 408b project beyond the winding 103 of the induction coil 109 toward the wall surface of the re-entrant part 120. Therefore, the winding 103 of the induction coil 109 can surely be prevented from coming into contact with the re-entrant part 120, thereby certainly avoiding blackening.

Furthermore, the distance between the distal end of each of the projections 408a and 408b and the outer surface of the induction coil 109 is within the range between 0.4 mm and 1.0 mm both inclusive. Therefore, the winding 103 of the induction coil 109 can surely be prevented from coming into contact with the re-entrant part 120, and the discharge efficiency can be enhanced.

(Embodiment 5)

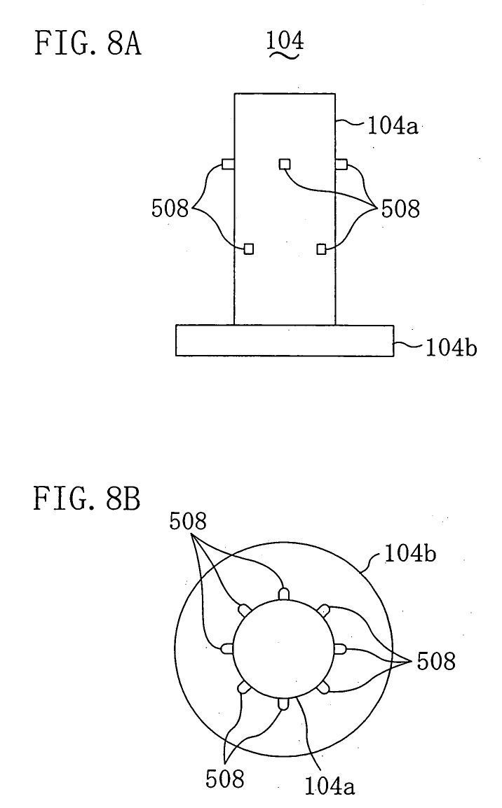

FIG. 8 shows a bobbin 104 used for a self-ballasted electrodeless fluorescent lamp of this embodiment. In the self-ballasted electrodeless fluorescent lamp of this embodiment, components other than projections 508, 508, . . . provided on the bobbin 104 are the same as those of the second embodiment. Thus, the projections 508, 508, . . . will be principally described.

The bobbin 104 used for the self-ballasted electrodeless fluorescent lamp of this embodiment is a bobbin 104 for split winding. In order to separate split parts of a coil from each other, a set of projections 508, 508, . . . are provided in a gap between the split parts of the coil and are used as a separation band (splitting wall). There exist two separation bands in this embodiment. Four projections 508, 508, . . . are provided every gap between the split parts of the coil and are located 90 degrees apart from each other with respect to the axis of the winding rod 104a. The projections 508 and 508 that are adjacent to each other in the circumferential direction of the winding rod 104a in a top view of FIG. 8B are those belonging to different splitting walls, and are located 45 degrees apart from each other with respect to the axis of the winding rod 104a in this embodiment. Each of these projections 508, 508, . . . has a semicircular distal end when viewed from a plane perpendicular to the axis of the winding rod 104a. Thus, when the winding 103 of the induction coil 109 is formed around the bobbin 104, the winding 103 of the induction coil 109 is formed closer to the winding rod 104a than to a virtual line linking between the adjacent distal ends of the adjacent projections 508 and 508 in the circumferential direction of the winding rod 104a. Therefore, the winding 103 of the induction coil 109 can surely be prevented from coming into contact with the re-entrant part 120, thereby certainly avoiding blackening.

Furthermore, the distance between the distal end of each of the projections 508, 508, . . . and the outer surface of the induction coil 109 is within the range between 0.4 mm and 1.0 mm both inclusive. Therefore, the winding 103 of the induction coil 109 can surely be prevented from coming into contact with the re-entrant part 120, and the discharge efficiency can be enhanced.

(Embodiment 6)

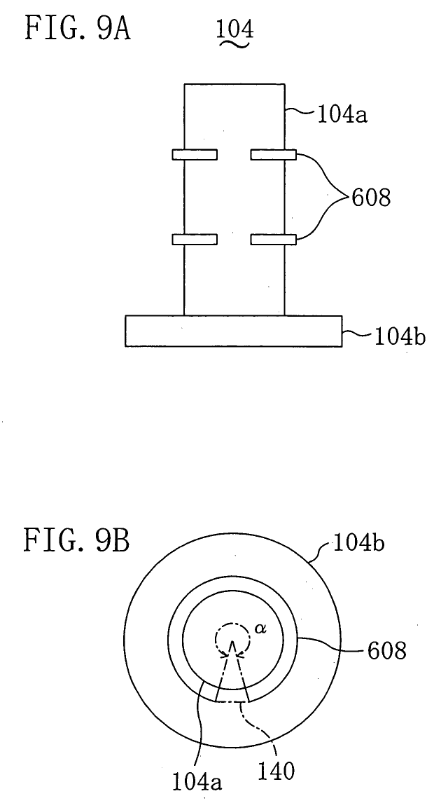

FIG. 9 shows a bobbin 104 used for a self-ballasted electrodeless fluorescent lamp of this embodiment. In the self-ballasted electrodeless fluorescent lamp of this embodiment, components other than projections 608 and 608 provided on the bobbin 104 are the same as those of the second embodiment. Thus, the projections 608 and 608 will be principally described.

The bobbin 104 used for the self-ballasted electrodeless fluorescent lamp of this embodiment is a bobbin 104 for split winding. In order to separate split parts of a coil from each other, each of projections 608 and 608 is provided in a gap between the split parts of the coil and is used as a separation band (splitting wall). There exist two separation bands in this embodiment. Each of these projections 608 and 608 has a generally annular shape provided with a cutout, and each of the projections 608 and 608 is continuously formed over an angle α of 320 or more degrees (330 degrees herein) in the circumferential direction of a winding rod 104a. That is, each of the projections 608 and 608 has a shape in which a part of a doughnut-shaped, punched disc is cut out, and each of them keeps projecting at a substantially constant amount of projection over the angle a in a direction of revolution as the axis of which the central axis of the tubular winding rod 104a is assumed. The substantially constant amount of projection means the amount to which each of the projections 608 and 608 projects higher than a winding 103 of an induction coil 109 when the winding 103 is formed on the winding rod 104a to constitute the induction coil 109. The winding 103 constituting the induction coil 109 is provided, in each space of (360-α) degrees where each of the projections 608 and 608 is not provided, closer to the winding rod 104a than a virtual line 140 linking between the corners of the projections 608 and 608 located at both ends of the space.

In the self-ballasted electrodeless fluorescent lamp of this embodiment, the projections 608 and 608 are continuously provided over 320 or more degrees in the circumferential direction of the winding rod 104a, and their height of projection is larger than the thickness of the wound winding 103 constituting the induction coil 109. Therefore, the winding 103 of the induction coil 109 can surely be prevented from coming into contact with the re-entrant part 120, thereby certainly avoiding blackening. It is undesirable that regions of the winding rod 104a where the projections 608 and 608 are provided should be those each extending over an angle less than 320 degrees, because the winding 103 of the induction coil 109 might excessively move closer to the re-entrant part 120 to cause blackening. Furthermore, since the projections 608 and 608 serve as splitting walls for split winding, the self-ballasted electrodeless fluorescent lamp of this embodiment can be produced at low cost.

Furthermore, the distance between the distal end of each of the projections 608 and 608 and the outer surface of the induction coil 109 is within the range between 0.4 mm and 1.0 mm both inclusive. Therefore, the winding 103 of the induction coil 109 can surely be prevented from coming into contact with the re-entrant part 120, and the discharge efficiency can be enhanced.

Since the embodiments described so far are taken as examples of the present invention, the present invention may be in other modes. For example, the number of projections may be larger than eight and may also be five through seven. The number of split parts of the coil obtained by split winding may be larger than three and may also be two. The shape of the projection is not limited to the above-mentioned shape but may be a hemisphere, a pyramid, a cone, or the like. These projections do not have to project perpendicularly from the winding rod but may project with them inclined. The induction coil may be wound in a single layer around the winding rod and may be wound in two or more layers with one layer stacked over another. As long as the above-mentioned projections are formed, other projections that are, for example, lower than the winding thickness of the induction coil may be formed.

Although in the above embodiments the fluorescent lamp is described, a high-intensity discharge lamp enclosing metal halide and mercury, for example, can also be prevented from the blackening of mercury by reaction with a glass tube of the lamp. Thus, the same effects as in the fluorescent lamp can be obtained.

The present invention is carried out in the above-described modes, thereby achieving the following effect.

Since projections projecting toward the re-entrant part beyond the induction coil are provided on the winding rod of the bobbin, the induction coil is restrained from coming into contact with the wall surface of the re-entrant part of the luminous bulb, thereby avoiding the occurrence of blackening inside the luminous bulb.

The entire content of Priority Document No. 2003-006820 is incorporated herein by reference.

What is claimed is:

1. A self-ballasted electrodeless fluorescent lamp comprising:
a luminous bulb enclosing light-emitting gas containing at least mercury and having a generally tubular re-entrant part;
an induction coil having a winding and a core, said induction coil being inserted into the re-entrant part;
a bobbin having a winding rod around which the winding of the induction coil is wound;
a ballast circuit for supplying high-frequency power to the induction coil; and
a base electrically connected to the ballast circuit, wherein
the luminous bulb, the induction coil, the ballast circuit, and the base are constructed as one unit,
at least one projection projecting toward the tubular wall surface of the re-entrant part is provided on the winding rod, and
the projection projects toward the tubular wall surface beyond the winding of the induction coil.

2. A self-ballasted electrodeless fluorescent lamp comprising:
a luminous bulb enclosing light-emitting gas containing at least mercury and having a generally tubular re-entrant part;
an induction coil having a winding obtained by winding a conductive wire and a core, said induction coil being inserted into the re-entrant part;
a bobbin having a winding rod around which the winding of the induction coil is wound;
a ballast circuit for supplying high-frequency power to the induction coil; and
a base electrically connected to the ballast circuit, wherein
the luminous bulb, the induction coil, the ballast circuit, and the base are constructed as one unit,
the winding of the induction coil is wound with it split into plural parts in a direction of the central axis of the winding rod by providing, between adjacent turns of the conductive wire located somewhere therealong, a gap running over the whole circumference of the winding rod,
a projection projecting toward the tubular wall surface of the re-entrant part is provided at least partly on a portion of the winding rod corresponding to the gap to separate the adjacent turns of the conductive wire from each other, and
the projection projects toward the tubular wall surface beyond the winding of the induction coil.

3. The self-ballasted electrodeless fluorescent lamp of claim 1, wherein
the winding rod is tubular,
a plurality of the projections exist, and
the winding of the induction coil is formed closer to the winding rod than a line linking between the adjacent corners or distal ends of the adjacent projections in the circumferential direction of the winding rod.

4. The self-ballasted electrodeless fluorescent lamp of claim 2, wherein
the winding rod is tubular,
a plurality of the projections exist, and
the winding of the induction coil is formed closer to the winding rod than to a line linking between the adjacent corners or distal ends of the adjacent projections in the circumferential direction of the winding rod.

5. The self-ballasted electrodeless fluorescent lamp of claim 1, wherein
the winding rod is tubular, and
the projection has a generally annular shape provided with a cutout and is continuously formed over 320 or more degrees in the circumferential direction of the winding rod.

6. The self-ballasted electrodeless fluorescent lamp of claim 2, wherein
the winding rod is tubular, and
the projection has a generally annular shape partly formed with a cutout and is continuously formed over 320 or more degrees in the circumferential direction of the winding rod.

7. The self-ballasted electrodeless fluorescent lamp of claim 1, wherein
the distance between the outer surface of the induction coil and the distal end of the projection is 0.4 mm through 1.0 mm both inclusive.

8. The self-ballasted electrodeless fluorescent lamp of claim 2, wherein
the distance between the outer surface of the induction coil and the distal end of the projection is 0.4 mm through 1.0 mm both inclusive.

9. The self-ballasted electrodeless fluorescent lamp of claim 1, wherein
the high-frequency power has a frequency of 50 kHz through 1 MHz both inclusive.

10. The self-ballasted electrodeless fluorescent lamp of claim 2, wherein
the high-frequency power has a frequency of 50 kHz through 1 MHz both inclusive.

11. An electrodeless fluorescent lamp operating device comprising:
a luminous bulb enclosing light-emitting gas containing at least mercury and having a generally tubular re-entrant part;
an induction coil inserted into the re-entrant part;
a bobbin having a winding rod around which the induction coil is wound; and
a ballast circuit for supplying high-frequency power to the induction coil, wherein
the winding rod is tubular and has a plurality of projections projecting toward the tubular wall surface of the re-entrant part,
the projections project toward the tubular wall surface beyond the induction coil, and
the induction coil is formed closer to the winding rod than a line linking between the adjacent corners or distal ends of the adjacent projections in the circumferential direction of the winding rod.

12. The electrodeless fluorescent lamp operating device of claim 11, wherein
the induction coil has a conductive wire and is wound with it split into plural parts in a direction of the central axis of the winding rod by providing, between adjacent turns of the conductive wire located somewhere therealong, a gap running over the whole circumference of the winding rod, and
the projections are provided on a portion of the winding rod corresponding to the gap to separate the adjacent turns of the conductive wire from each other.

13. An electrodeless fluorescent lamp operating device comprising:
a luminous bulb enclosing light-emitting gas containing at least mercury and having a generally tubular re-entrant part;
an induction coil inserted into the re-entrant part;
a bobbin having a winding rod around which the induction coil is wound; and
a ballast circuit for supplying high-frequency power to the induction coil, wherein
the winding rod is tubular and has a projection projecting toward the tubular wall surface of the re-entrant part, and
the projection projects toward the tubular wall surface beyond the induction coil, has a generally annular shape provided with a cutout, and is continuously formed over 320 or more degrees in the circumferential direction of the winding rod.

14. The electrodeless fluorescent lamp operating device of claim 11, wherein
the distance between the outer surface of the induction coil and the distal end of each of the projections is 0.4 mm through 1.0 mm both inclusive.

15. The electrodeless fluorescent lamp operating device of claim 13, wherein
the distance between the outer surface of the induction coil and the distal end of the projection is 0.4 mm through 1.0 mm both inclusive.

16. The electrodeless fluorescent lamp operating device of claim 11, wherein
the high-frequency power has a frequency of 50 kHz through 1 MHz both inclusive.

17. The electrodeless fluorescent lamp operating device of claim 13, wherein
the high-frequency power has a frequency of 50 kHz through 1 MHz both inclusive.
